(19) United States
(12) Patent Application Publication
(10) Pub. No.: US 2010/0183280 A1
(43) Pub. Date: Jul. 22, 2010

(54) CREATING A NEW VIDEO PRODUCTION BY INTERCUTTING BETWEEN MULTIPLE VIDEO CLIPS

(75) Inventors: Gerald Thomas Beauregard, Singapore (SG); Srikumar Karaikudi Subramanian, Singapore (SG); Peter Rowan Kellock, Singapore (SG)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: MUVEE TECHNOLOGIES PTE LTD., Singapore (SG)

(21) Appl. No.: 12/635,268

(22) Filed: Dec. 10, 2009

Related U.S. Application Data
(63) Continuation of application No. PCT/SG2008/000472, filed on Dec. 10, 2008.

(51) Int. Cl. H04N 5/93; H04N 7/087; G06F 3/01

(52) U.S. Cl. 386/54; 386/84; 386/E05.003; 715/719

(57) ABSTRACT

A method is proposed in which multiple video clips are temporally-aligned based on the content of their audio tracks, and then edited to create a new video production incorporating material from two or more of those video clips.

### FIELD OF THE INVENTION

The invention relates generally to computer generation of video productions. In particular, the invention relates to automated editing of multiple video clips into a single video production synchronized to a substantially common audio track.

### BACKGROUND OF THE INVENTION

The last few years has seen a rapid rise in the creation of video content, particularly of the type known as “user-generated content” or “UGC”. This is video created by non-professional videographers, literally anyone equipped with a device capable of recording video content. This content is sometimes shared by playback from the shooting device, for example in the case a video camera connected to a television, but increasingly it is transferred to a computer to enable other forms of storage and/or sharing. These include forwarding by email and upload to video-hosting sites such as YouTube, Yahoo Video, shwup.com, and others.

The main driver of this growth in video creation has been the rapid increase in the range of devices capable of shooting digital video, and an equally rapid drop in the price of such devices. Until a few years ago, practically the only device available to consumers for shooting video was the tape-based camcorder, a device which is both quite bulky and quite expensive, typically in the region of US$1000. Such camcorders are still available and are still widely used, but over the last few years their numbers have been overtaken by other types of device, including camcorders which record to hard disk and to solid-state (e.g. “flash”) memory, “digital still cameras” or “DSCs” which are today often capable of recording video as well as still images, and camera phones which integrate a camera into a mobile phone and are typically capable of recording both still images and video. The price of such devices is dramatically lower than the traditional camcorder, in many cases below US$100.

Alongside this growth in the shooting of video, there has been a corresponding growth in the desire to edit video and to do so quickly and easily. Note that the term “editing” in the context of video is taken to mean not only removing unwanted parts of the raw input video, but also the application of a wide range of video processing and enhancement techniques familiar to most people through television: transitions between shots, special effects, graphics, overlaid text, and more.

Editing is sometimes performed manually on computers using programmes known as “Non-Linear Editors” or “NLEs” such as Apple iMovie™, Adobe Premiere™ or Windows Movie Maker™. However there has also been growth in “automatic editing” software which makes the process of creating a final edited production dramatically easier, faster and accessible to far more people. This type of software typically operates firstly by analyzing the raw input video (and sometimes its associated audio) to determine certain characteristics such brightness, colour, motion, the presence or absence of human faces, etc. It then applies editing rules known to experienced human video editors. For example, one exponent of this field is muvee Technologies Pte Ltd who have created automatic editing software for several platforms including Windows PCs, the Internet, and camera phones from Nokia, LG and others.

Patent GB2380599 (Peter Rowan Kellock et al) is about automatically or semi-automatically creating an output media production from input media including video, pictures and music. The input media is annotated by, or analyzed to derive, a set of media descriptors which describe the input media and which are derived from the input media. The style of editing is controlled using style data which is typically specified by the user. The style data and the descriptors are then used to generate a set of operations on the input data, which when carried out result in the output production. This step incorporates techniques that can be taken as capturing a human music video editor's sensibilities—resulting in a production where the editing, effects and transitions are timed to an input music track. Since no significant constraints are placed on the input media and most of the tedious operations are automated by computer means, it presents a least effort path for the average camcorder/camera user to create an enjoyable stylish production. The commercial product by muvee Technologies named muvee autoProducer™ is based on the above invention.

U.S. Pat. No. 7,027,124 (Jonathan Foote et al) describes a method for automatically producing music videos. Transition points in the audio and video signals are detected and used to align the video signal with the audio signal. The video signal is edited according to its alignment with the audio signal and the resulting edited video signal is merged with the audio signal to form a music video.

Published Patent Application GB2440181 (Gerald Thomas Beauregard et al) describes a method for intercutting user-supplied material with a pre-existing music video to create a new production. In the pre-existing music video, the video content is synchronized with the music track; for example, the singer's mouth movements are coordinated with the singing (even if the singing was lip-synced in order to make the music video). In the new production, material taken from the pre-existing music video retains its video/audio synchronization with the music track. However, segments consisting of user-supplied video have no specific synchronization with the music track. For example, user-supplied video of an amateur lip-syncing to the song will not be properly lip-synced in the new production.

Thus the prior art thus includes a number of approaches to automatic video editing, some specific to the creation of music videos. However, the prior art does not provide means of automating the creation of productions in one specific and important set of scenarios: those in which the production will comprise portions of several pieces of raw video which have a pre-existing synchronization relationship relative to each other by virtue of having substantially common soundtracks and in which it is desired to preserve this relationship in the production. Examples of such scenarios are:
a) The Multi-Camera Live Event scenario, in which multiple cameras simultaneously capture a single live event (typically each camera shooting from a different angle) and in which the goal is to create automatically an edited production comprising portions taken from more than one of the cameras. These include live performances of music, dance, theatre, etc.
b) The Lip-Sync scenario, in which a number of distinct visual performances is performed each one in synchronization with a common soundtrack. These include cases where one or more people dance, lip-sync, play “air guitar” or otherwise perform to the same piece of recorded music, and in which each performance may be at a different time and/or different place. Note that pretending to sing or to play a musical instrument in time with a favourite pop song is a popular theme in user-generated video shared on online media hosting sites such as YouTube.

Considering scenario a) above, the Multi-Camera Single-Event scenario, several approaches have traditionally been employed to create synchronised productions comprising video shot simultaneously on multiple cameras. One approach, widely used by professional videographers, is to connect (by wire or wireless) all the cameras to a common synchronization signal such as SMPTE timecode at the time of shooting. Later this common signal (or data derived therefrom) is used to align the video clips during manual editing. Another approach is to record a common audiovisual reference at the start of the recording and use it to align the multiple pieces manually at the time of editing; for example the “clapperboard”, an icon of film-making which has been used since the earliest days of film, serves this purpose. Another option is to align the pieces of video as well as possible during editing simply by relying on careful observation of the visual and/or audio parts of recorded material, without any special techniques to assist in such alignment.

None of the above approaches is well-suited to UGC, particularly when automatic video editing is to be applied. Consumer camcorders, DSCs, camera phones, and other mass-market video recording devices do not support connection to a common timing reference. Amateur videographers do not use clapperboards, and in many cases it would be impossible or socially unacceptable to do so, for example just before the start of a public performance. Alignment at the time of editing by careful observation is tedious and would detract greatly from the primary advantages of automatic video editing, namely speed, convenience, simplicity, and the lack of a need for professional production skills.

### SUMMARY OF INVENTION

The current invention aims to provide a new and useful video editing system and method, and preferably to overcome or at least mitigate some or all of the above limitations.

A preferred embodiment of the invention makes it possible to create a finished production from multiple input video clips, and to do so fully automatically or at least with much less human intervention than is possible with the prior art. It does this in essentially two steps:
1. It uses the fact that in scenarios such as those listed above, the audio track is identical, or substantially similar, for every input video clip (or for at least some part of each clip) in order to establish synchronization between them. This is based upon techniques for audio synchronization known in the prior art, such as establishing the relative synchronization which gives the highest cross-correlation value for an audio parameter extracted by signal analysis of the audio track of each clip.
2. It applies automatic editing techniques to the input video clips to make the finished production by concatenating segments of video selected from the clips.

The invention has application to the multi-camera live scenario and lip sync scenario described above, and in addition in a number of other cases including the following:
The Multi-Take scenario, in which one or more cameras capture a series of “takes” of the same work, but not in perfect sync with a previously recorded performance of that work. For example a band can record multiple takes of the same song, recording video of each take. The invention allows them to create a finished video that includes footage from different takes, all of them synchronized to the audio recording from one of the takes, using “time warping” to account for variations in the speed of performance of each take.
The Partial Overlap scenario, in which the video clips are not entirely simultaneous, but are partially overlapping, and in which the overlapping sections have a substantially-common soundtrack. On example is a crowd at a sports event in which many people record video clips which are shorter (typically much shorter) than the entire event. If there are sufficient such clips which start and end at different times, there are likely to be many sections of overlap, and—despite the different positions of people in the crowd—there will be similarities in the audio of these overlapping sections. These can be used to establish the common synchronization of some or all of the clips, so that they can then be edited automatically into a final production in which relative synchronization is preserved. Another example of such a case is in one in which multiple people are positioned at different locations along the sides of a road or track and record video of passing vehicles, people, animals etc. This allows video productions to be created automatically of processions, races, etc in which the productions can span sections of the event longer than any one video clip (potentially the entire procession or race).

An attractive feature of preferred embodiment of the invention is that there is no need for a priori knowledge about the creation of a joint production. For example, different people shooting video of an event may have no intention of making a joint production, nor any foreknowledge that a joint production may be made, nor even the knowledge that anyone else is shooting the same event. Similarly, in case of distinct visual performances performed separately but each in synchronization with a common soundtrack, such as different people miming to the same piece music in different places and/or at different times, there is no need for the different people involved to coordinate with each other in any way, nor indeed to even know of the existence of the other performances. In all cases the decision to make a finished production from the multiple input video clips can be made after some or all of the video has been shot.

### BRIEF DESCRIPTION OF THE FIGURES

Preferred features of the invention will now be described, for the sake of illustration only, with reference to the following figures in which:

FIG. 1 is a flow chart summarizing the steps of a method which is an embodiment of the invention to generate a new video production from a set of video clips that are time-aligned using the similarities of their audio tracks.

FIG. 2 is a construction diagram illustrating alignment of multiple video clips to a single separately-specified reference audio track, and intercutting of those video clips to create a new production.

FIG. 3 is a construction diagram illustrating alignment of multiple video clips, where the audio track of one of those video clips is used as the reference.

FIG. 4 is construction diagram illustrating alignment of multiple video clips based on their audio tracks, in the case where there is no single video track covering the entire duration of the resulting production.

FIG. 5 is a construction diagram showing how multiple takes recorded in a single video file can be divided into multiple clips, time-aligned based on their audio tracks, and intercut to create an output production.

FIG. 6 is a plan view of a live scenario which could generate input material suitable for construction as per FIG. 1, FIG. 2, or FIG. 3.

FIG. 7 is a schematic illustration of the miming scenario in which several people, possibly in different locations and at different times, creating video clips of themselves performing in sync with a pre-recorded audio track.

FIG. 8 is a schematic illustration of a street parade scenario in which several people make video recordings of a live event from different locations.

FIG. 9 is a flowchart summarizing the steps for aligning a video clip with a reference audio track using cross-correlation of the loudness envelope of the reference audio track and the audio track of the video clip.

FIG. 10 is a flowchart for a method for constructing an output production given at least two time-aligned video clips.

FIG. 11 is a variant of FIG. 1 with the additional step of allowing the user to mark highlights and/or exclusions, for example via a user interface such as that shown in FIG. 12.

FIG. 12 shows a possible user interface for indicating highlights and exclusions in multiple time-aligned video clips.

FIG. 13 is a construction diagram showing the creation of an output production from multiple video clips that are aligned to a reference audio track, and for which the user has marked some parts as highlights or exclusions.

### DESCRIPTION OF THE PREFERRED EMBODIMENT

### General Cases

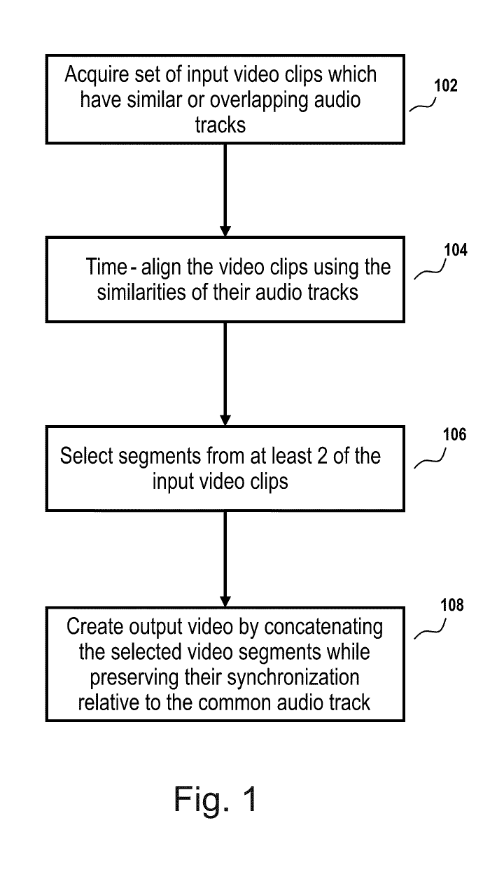

FIG. 1 is a flow chart summarizing the steps of a method which is an embodiment of the invention to generate a new video production from a set of video clips that are time-aligned using the similarities of their audio tracks.

In the first step 102, a set of video clips that have substantially similar or overlapping audio tracks is acquired. In the second step 104, these video clips are time-aligned using similarities of their audio tracks. In the third step, 106, segments are selected from at least 2 of the input video clips. In the final step 108, an output video is created by concatenating the video segments while preserving their synchronization relative to the common audio track.

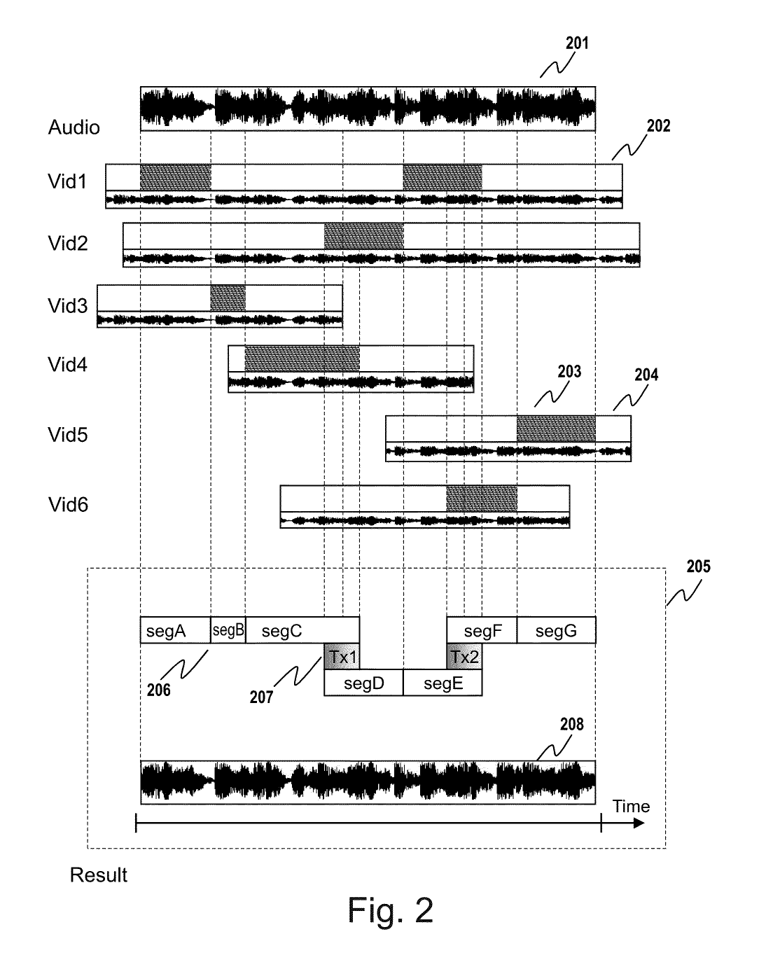

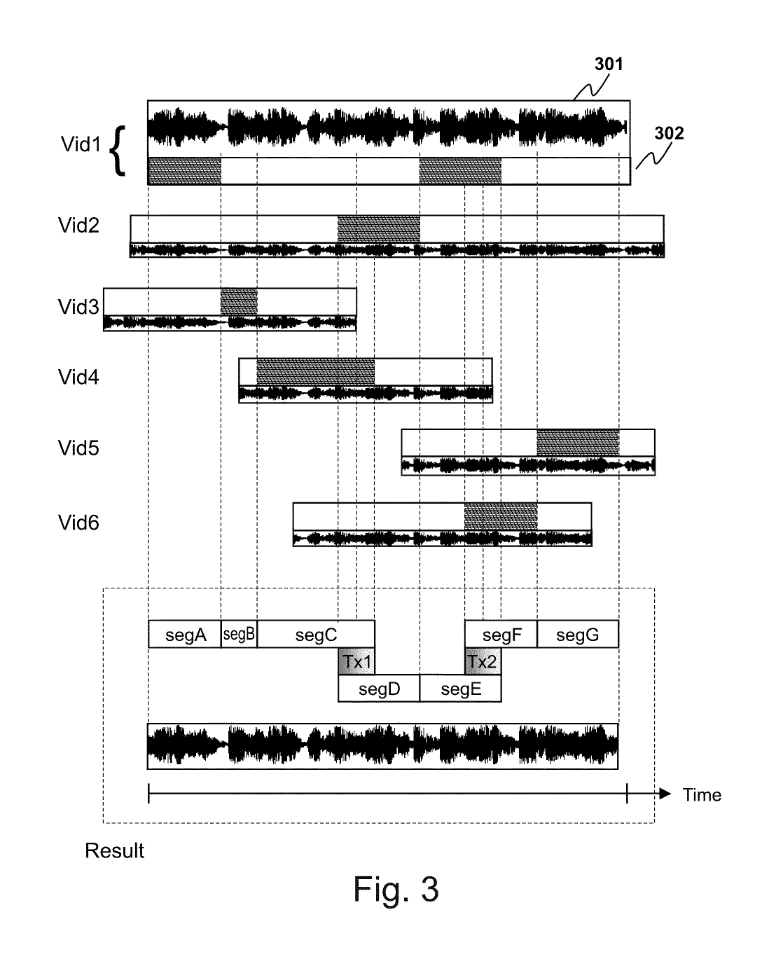

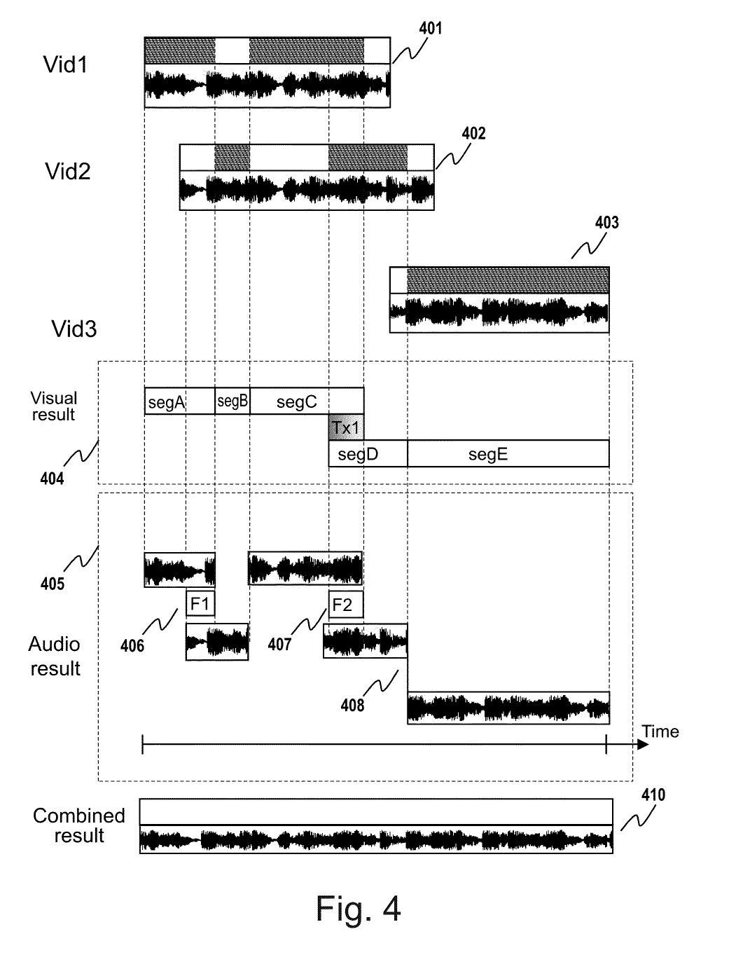

There are three general cases for aligning the video tracks based on the audio tracks, and these are illustrated in the construction diagrams in FIG. 2, FIG. 3, and FIG. 4.

### Standalone Reference Audio Track

FIG. 2 is a construction diagram illustrating the case where there is a standalone reference audio track “Audio” (labelled 201) not associated with any of the video clips. The reference audio track 201 may be, for example, a recording of a song taken from CD or mp3. Alternatively, in the Multi-Camera Live Event scenario, the reference audio may be recorded during the event, but independently from any camera, either using a stand-alone audio recording device and microphone, or perhaps via a stereo mix from a mixer or PA (public address) system.

The video clips (“Vid1”, “Vid2”, “Vid3”, “Vid4”, Vid5”, “Vid6”) themselves each have their own audio tracks. Using well-known audio signal processing methods, some of which are discussed below, the video clips are time-aligned to the reference audio track 201.

The video files may span the entire duration of the reference audio track, as does Vid1 (labelled 202), or cover only a portion of the duration of the reference audio track, as does Vid5 (labelled 204).

Using methods that will be described in greater detail below, segments are selected from the multiple video tracks such that collectively, the segments span the full duration of the reference audio track. The shaded area 203 of video clip 204 is one such segment selected for inclusion in the output production 205.

The visual portion of the final production 205 consists of segments (“segA”, “segB”, “segC”, “segD”, “segE”, “segF”, “segG”) selected from the multiple video tracks, such that collectively, the segments span the full duration of the reference audio track. The audio portion of the final production 205 is a copy 208 of the reference audio track 201.

In the visual portion of the final production 205, the transition from one segment to the next may be an instantaneous cut 206, or it may be a transition of non-zero length for example a dissolve 207 during period Tx1, wipe, or any other type of transition well-known to those skilled in the art. The video track of the final production 205 in the period Tx1 contains elements of segC and segD, and in the period and Tx2 contains elements of segE and segF.

This construction diagram applies particularly well to the Lip-Sync scenario, in which several people make a video recordings of themselves dancing, lip syncing, or playing along with a pre-recorded song playing on a stereo. The audio tracks of the video recording will of course include whatever portion of the song was playing on the stereo during that take.

Reference Audio from One Video Clip

FIG. 3 is a construction diagram illustrating alignment of multiple video clips, where the audio track 301 of one of those video clips Vid1 is used as the reference. FIG. 3 is very similar to FIG. 2, the primary difference being the source of the reference audio track: in FIG. 2, it's a separate audio track, whereas in FIG. 3 the reference audio track is taken from one of the input video files, which consists of an audio part 301 and video part 302.

This construction diagram applies especially well to the Multi-Camera Live Event scenario, in which several video cameras simultaneously record a live performance. The reference audio track can be taken from the audio track of one of the video camera's recording of the performance.

A special case of FIG. 3 is that in which the video whose audio track is used as the reference audio track is a pre-existing music video. In this case, the output production in the construction diagram in FIG. 3 can be thought of as one in which video clips shot by an end-user are intercut with a pre-existing music video.

### No Reference Audio Track Covering Entire Duration

FIG. 4 is construction diagram illustrating the case of alignment of multiple video clips based on their audio tracks, in the case where there is no single video or audio track covering the entire duration of the resulting production.

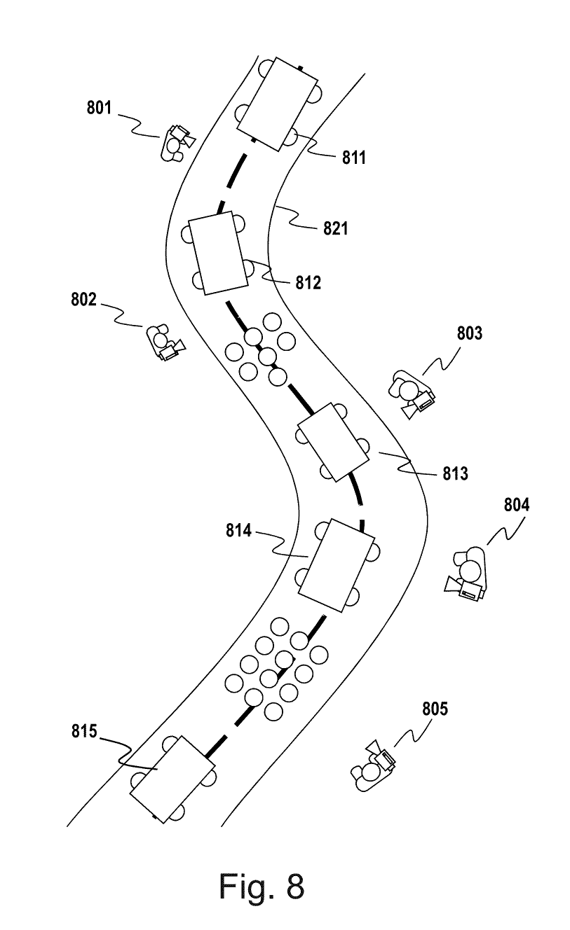

This case applies could apply when there are multiple cameras capturing portions a live event, where none of the cameras captures the entire event. The key requirements for the method to work in this case is that collectively all the clips cover the entire duration of the event, and that each clip overlaps (in time) at least one other clip. One example is that of multiple cameras shooting video of a parade, as discussed in greater detail with reference to FIG. 8.

The input video clips Vid1, Vid2, Vid3 (labelled 401, 402, 403) collectively cover the entire duration of the final production 410. A pair of successive video clips may overlap substantially (for example clips 401, 402) or only a bit (for example clips 402, 403).

The visual portion 404 of the final production is created by selecting segments from the multiple video clips. Over some time ranges of the output production, segments can be taken from more than one clip. For example, for most of the first half of the production shown in FIG. 4, segments can be selected from either of two video clips 401, 402. For the latter portion of the production, however, the output segment must be taken from one specific clip 403, as that's the only clip available in that time range.

In this case, there's no single audio track that spans the entire duration of the output production, so the audio portion 405 of the output production is created by concatenating segments of the audio tracks from the clips. This is done using techniques described below. Depending on the circumstances and the desired effect, it may be preferable to crossfade from one audio segment to the next (e.g. at times Tx1 and Tx2 labelled respectively as 406, 407), in others it may be preferable to simply cut 408.

One possible approach would be to use a cut in the audio track if there's a cut in the visuals, and crossfade the audio if there's a dissolve or other non-zero length transition in the visuals. However, this is only one possibility, and in fact the cutting and/or crossfading in the audio track can essentially be independent of the editing of the visuals.

For all three of the general cases represented in FIG. 2, FIG. 3, and FIG. 4, the output production may be saved into a single video file containing both a video track and audio track. This is illustrated for example in FIG. 4, in which the visual portion 404 and audio portion 405 of the output production are combined to create a single file 410. The saved video file could be in any one of the numerous and ever-growing types of video files, for example (but not limited to) MPEG-1, MPEG-2, MOV, AVI, ASF, or MPEG-4.

In all three of the above general cases represented in FIG. 2, FIG. 3, and FIG. 4, all the input video material has some inherent synchronization with some common audio source. It would of course be possible to include in the output production additional or alternative material that is not synchronized at all such as still images, abstract synthetic video, or video not shot in time with the common audio source. For example, a pop music video typically would show members of a band performing (or pretending to perform) a song, but might also show band members acting in a storyline in which their actions are not choreographed to the music.

### Multi-Take Scenario

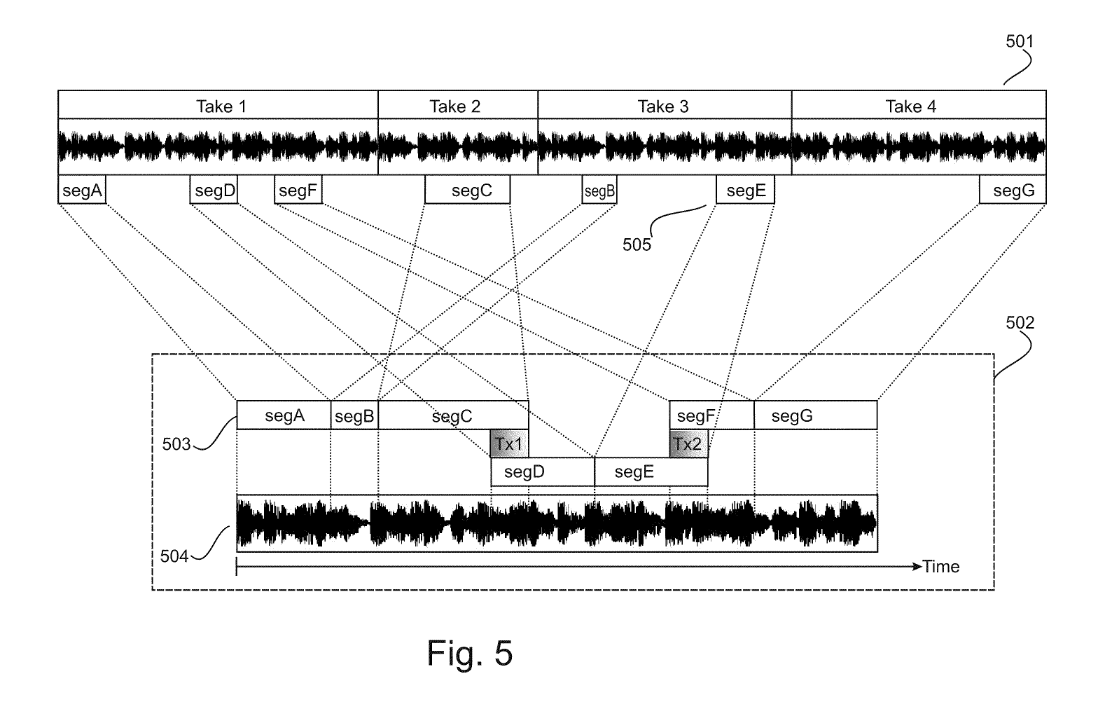

FIG. 5 is a construction diagram showing how multiple takes recorded in a single video file can be divided into multiple clips, time-aligned based on their audio tracks, and intercut to create an output production.

The input video file 501 contains multiple shots, each of which corresponds to a single performance or “take” of a work. If the video recording is made using a conventional tape-based DV camcorder, each take would start when the user presses the record button on the camcorder and end when the user presses the pause or stop button. When the video is transferred (“captured”) into the PC, each take may be captured as a separate file. Alternatively, it may be captured as a single video file containing the multiple takes. In this case the shot boundaries can be detected automatically using shot boundary detection techniques, of which there are many described in the literature.

Portions of the input video are combined to create an output production 502, consisting of a video track 503 and audio track 504. We now describe how the audio track 504 is created.

In the Multi-Take scenario, the takes are not necessarily performed strictly in time with a reference audio track. Consider, for example, a classical piano competition in which all the performers must play the same piece of music (e.g. a Mozart piano sonata). Even if the performers have all had the same teacher, and been inspired by same recordings of the piece, each performance will have slightly different timing.

Nonetheless, based on the audio tracks of the videos, it is possible to align videos of each competitor's performance to a reference audio track 504, i.e. a single recording of the piece. The reference audio track 504 could be the audio track from one of the takes, or another recording altogether, e.g. a CD recording of a famous virtuoso playing the same Mozart piano sonata. This can be accomplished using, for example, applying a Dynamic Time-Warping (DTW) algorithm to find the respective optimal alignments of the spectrograms (or more technically, Short-Time Fourier Transform Magnitude, STFTM) of the audio tracks of the individual takes with the reference audio track.

Once the time alignment and time-varying warping parameters are known, an output production including video segments from the various takes can be constructed, with the video dynamically sped up or slowed down as required to maintain proper sync with the reference audio track. Each of the segments segA, segB, segC, segD, segE of the output production is time-aligned to the audio track 504. For example, segment 505 is time-aligned to a point in audio track 504 where the audio is most similar to the audio at its source position in the input video file 501. The segments may simply be concatenated (e.g. segB and segC), or there may be transitions between them, for example dissolves during periods Tx1 and Tx2.

Another application of such time-warping is in cases where a band is creating a music video, and the video includes clips from live performances. Typically in a music video, a studio recording of a song is used as the soundtrack, as it provides the best possible sound quality. Live performances of the song will inevitably have slightly different timing from each other and from the studio recording. Nonetheless, using the Dynamic Time-Warping method mentioned above, it is possible to time-align videos of live performances with the studio recording. The input video material might also contain clips of the band lip-syncing to their studio recording; for such lip-synced clips, no time-warping would be necessary. The input video may also include video of the musicians in the studio during the recording process.

### Non-Musical Cases

Note that the “performance” need not necessarily be of a piece of music. It could be any type of performance where audio is generated with similar enough timing that alignment of the multiple performances is possible. Examples include individuals or groups of people reciting a prayer (e.g. the Lord's Prayer) or a pledge (e.g. the US Pledge of Allegiance). In both these cases, the words used across multiple performances are likely to be identical (as they essentially follow a set script), and the timing is likely to be fairly similar as well (as they are generally learned and recited in groups, so peer pressure tends to result in common timing). In such cases, using dynamic time-warping, the video clips could be time aligned to a reference audio track containing a single recording of the scripted prayer or pledge.

### Multi-Camera Live Event Scenario

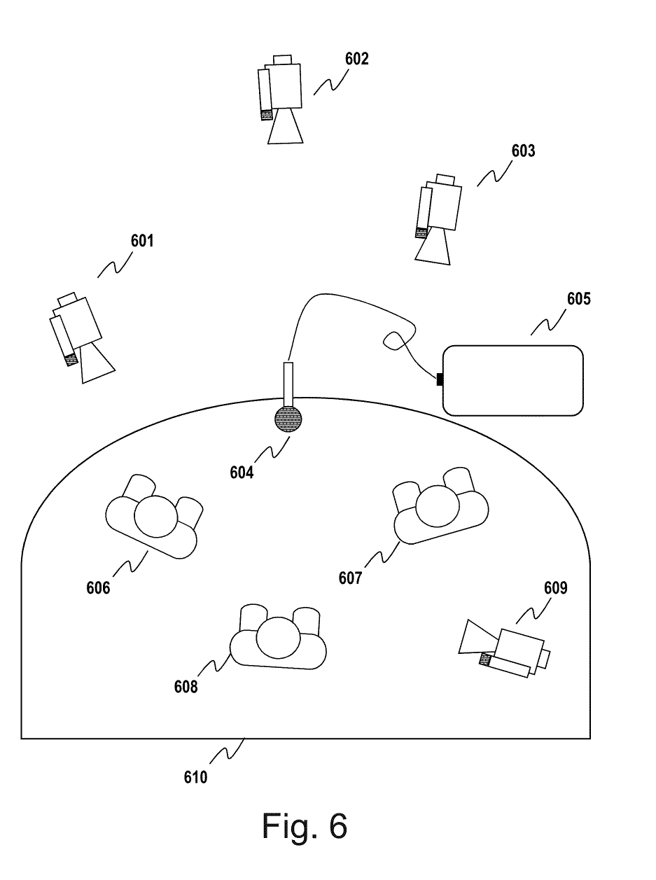

FIG. 6 is a plan view of a live scenario which could generate input material suitable for construction as per FIG. 2 or FIG. 3. In this scenario, a band with several members several members 606, 607, 608, is performing on a stage 610. The performance is recorded by several video cameras 601, 602, 603, 609 shooting from various angles.

The cameras would typically be positioned to capture the most interesting aspects of the performance, for example close-ups of each of the band members, plus wide shots of the entire band, and possibly even one or more cameras pointing away from the stage and to capture the audience's reaction. The cameras may on or off stage, and may be stationary (e.g. tripod mounted) or handheld.

The cameras are not connected to each other, nor are they connected to any common timing references. The cameras may be started and stopped at different times. It's not necessary that all the cameras, or even any of the cameras, capture the entire performance in a single shot.

Most video cameras are equipped with microphones (either built-in, or attached), so each video camera captures not just the visuals, but also the sound from the performance. Since each camera is at a different position, it will capture a somewhat different sound—e.g. a camera which is further away from the stage may capture more audience noise and more room reverberation than another camera positioned closer to the stage.

A “master” audio recording of the performance may be captured using dedicated audio recording means, such as a microphone 604 and audio recorder 605. The recording captured on this recorder serves as the “master” audio track for synchronizing the video/audio captured with the aforementioned video cameras.

This is just one of many ways the master audio track may be captured. In many live performances, the performers' instruments and voices are captured by multiple microphones, whose signals are combined with a mixing desk, amplified, and played to the audience through loudspeakers. (In the case of electric or electronic instruments, for example electronic keyboards, the instruments may even be connected directly to the mixing desk). In such cases, the master audio track may be recorded from the mixing desk.

The master audio track would typically be stereo (2-channels), though in some applications it may fewer (1-channel mono) or more (multitrack audio capture).

In low-budget situations, the master audio track could simply be the audio track from one of the video cameras, provided that camera captures the entire performance in a single shot. In such cases the separate mic 604 and audio recorder 605 are not necessary. This case corresponds to the scenario described above with reference to FIG. 3.

After the performance, the video recordings from the multiple cameras plus the master audio track are transferred to a computer. The various video recordings are aligned to the master audio track, and intercut with each other as per the construction diagram in FIG. 2.

A live performance of a band is just one example of a live event for which multiple video clips could be time-aligned based on their audio tracks. Others include any other sort of musical performance; parties/raves, where the video might show people dancing; speeches or lectures; and theatre performances.

Multiple Cameras Each with Multiple Takes in One File

One useful extension to the above ideas is to have multiple cameras, each capturing multiple takes. Consider a band making a music video for a song which they've previously recorded in a studio. As in the live performance scenario, it would be desirable to have multiple cameras to capture the band members playing/singing their song from various angles. The band may do multiple takes, each take covering all or part of the song. For each take, the cameras could be moved to different positions; for example, if there's a guitar solo, it may be desirable to do several takes during which all available cameras are capturing only the antics of the lead guitarist.

When the video from each camera is “captured” into a PC, it may be captured as a set of discrete files, or as a single file containing multiple shots. If several camcorders are used, there will certainly be multiple files, each containing multiple shots. Using trivial extensions to the methods described above, each of the video files can be split into multiple shots using shot boundary detection techniques, and each of the shots can be time-aligned to the reference audio track, and combined to create an output production.

### Detection of Takes Using Audio

Stopping & starting a video camera (or several video cameras) for each take may be inconvenient. It would typically be more convenient to leave the camera running continuously, and only start/stop playback of the reference audio track to which performers are lip-syncing, dancing, etc. In such cases, it would still be possible to detect and separate the takes using the audio track of the video file.

One simple approach, applicable to most musical performances, would be to detect sections in the audio tracks where the audio level is unusually low for long stretches. Assuming the music itself does not normally include very long quiet sections, these stretches where the audio level is unusually low could be interpreted as gaps between successive takes.

### Lip-Sync Scenario

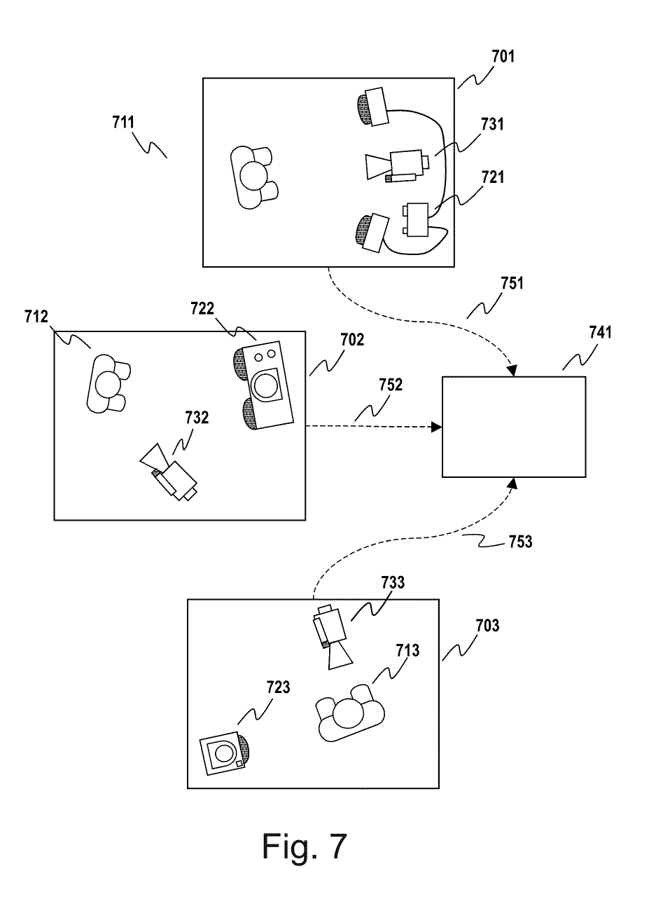

FIG. 7 is a schematic illustration of a Lip-Sync scenario in which several people, possibly in different locations and at different times and totally unknown to each other, create video clips of themselves performing in sync with a pre-recorded audio track. The pre-recorded audio track most typically would be music, for example a commercially recorded pop song, but could possibly be non-music, for example dialog from a film or comedy skit.

Several possible recording scenarios are illustrated. At the first location 701, a person 711 is shown using a home stereo system 721 to play the pre-recorded audio track (for example from a CD or mp3 player). The person lip-syncs and/or dances in time with the reference track. A video camera 731 captures the user's mimed or lip-synced performance; via its microphone, the video camera also captures the pre-recorded audio track played back via the audio system 721.

The scenarios at the other locations 702, 703 are similar, the only difference being the type of audio playback system that's used. At location 702, the person 712 is using a portable stereo audio system 722 to play the reference audio track. The user's performance and the pre-recorded audio are captured via video camera 732. At location 703, the person 713 is using a monophonic audio system to play back the pre-recorded audio. The user's performance and the pre-recorded audio are captured via video camera 733.

Performances by the users are transmitted 751,752,753 to a central location 714 where the multiple performances are synchronized on the basis of their substantially common audio tracks, and edited to form a single coherent production. Note that regardless of details of the type of audio players and camcorders used by each user (mono, stereo, surround sound, from CD or mp3 player, etc), the audio recorded by the camcorders will be substantially similar, to a degree that well-known audio cross-correlation techniques such as those described herein will readily be able to establish the necessary synchronization between them.

The transmission from each user's location to a central location would typically happen at different times. A variety of transmission methods is possible, ranging from sending a video tape by post to sending a video file via a computer network, for example the Internet.

For illustration only, FIG. 7 shows multiple users in multiple locations, each capturing a performance with a single camera. Many other variants in numbers of users, locations, and cameras are possible. A user could create multiple videos in multiple takes, each covering all or only part of the song. Each take could be captured by one or more than one camera. All video material used to create the production could be from a single user. All the video could be shot in a single location. Each video could consist of a performance by two or more people as opposed to a single user.

If there is a pre-existing music video for the song, it can be used as another of the input videos. The video clips of people dancing, miming, or lip-syncing to the song can be synchronized to the song on the basis of the audio tracks, and then intercut with the pre-existing music video to create an output production. Many aspects of such a production—including segment durations, transitions, and effects—could be chosen using methods described in GB2440181 and GB2380599, with the crucial distinction that in the present invention, user-supplied video that was shot in sync with the reference audio would be properly synced in the output production.

If the equipment has the appropriate connections, the video camera can capture the pre-recorded audio track directly instead of via a microphone. For example, at location 701, if the stereo system 721 has a “line out” connection, that could be connected via a suitable cable to a “line in” connector on the video camera. The advantage of doing so is that the audio track of the video clips would have less extraneous noise, and thus be more similar to and easier to synchronize with the reference pre-recorded audio track. Assuming the video camera has (at least) a stereo audio input, the pre-recorded audio track could optionally be fed to one or more channels of the video camera's audio input (e.g. the Left input in a stereo case), and live audio such as the user actually singing fed to one or more other channels (e.g. the Right channel). In the stereo example, the left channel would be use for synchronization with the reference track.

### Partial Overlap Scenario

FIG. 8 is a schematic illustration of a street parade scenario in which several people make video recordings of a live event from different locations.

In this scenario, several people carrying cameras 801, 802, 803, 804, 805 at various locations along a street 821 each make recording of all or parts of an event, in this case a street parade with floats 811, 812, 813, 814, 815.

In a typical parade, there will be music blaring from the floats, and lots of other miscellaneous sound such as crowd noises. The people recording the event will capture slightly different overall sound “mixes” depending on their positions relative to the sound sources and the directions in which their video cameras are pointed.

None of the recordings of the event necessarily covers the entire duration of the event, and hence it is not possible for any one of the audio components of the video recordings to serve as a master or reference track to which all the others can be aligned. Nonetheless, it is possible to align all the recordings provided a few conditions are satisfied: first, collectively the recordings from all the cameras must cover the duration of the whole event (or at least the part of the event which will be covered by the final video production); second, there must be sufficient temporal overlap between nearby cameras (which have sufficiently similar audio tracks) in order to do partial alignments of audio recordings from those cameras.

For the case illustrated in FIG. 8, for example, suppose cameras 801 and 802 are sufficiently close that the audio they capture would allow temporal alignment of temporally-overlapping clips from those two cameras. Suppose that cameras 801 and 803 are far enough apart that the audio they capture is too different to permit reliable alignment based on their audio tracks. Alignment of the clips captured by cameras 801 and 803 is still possible by aligning the clips from both those cameras to clips captured with a third camera that is close enough to both of them, in this case camera 802.

First, clips from cameras 801 and 802 are aligned, using methods described later (for example cross-correlation of loudness or other features extracted from the audio signal). Next, clips from cameras 802 and 803 are time-aligned, again based on their audio tracks. Now that clips from camera 803 are aligned to those from camera 802, and those from camera 801 are also aligned to those from camera 802, it's a simple matter to calculate the alignment of clips from camera 801 relative to those from camera 803.

More generally, given a set of N clips which collectively cover the full duration of an event, but whose relative time alignment is initially unknown, their relative alignment is determined as follows. First, we compute the cross-correlation of a feature of the audio tracks for all N×(N−1) possible pairs of clips. For the pair that has the highest peak in its cross-correlation, we create a new audio track by combining the audio tracks of the two clips in that pair, cross-fading between the two audio tracks in the time range that they overlap. With the relative alignment of those two clips now established, there are now in effect N−1 clips whose relative alignment needs to be determined. We then repeat the above procedure for the (N−1)×(N−2) clips to yield a new pair of clips with maximal cross-correlation peaks, and create another new audio track for the new pair. Thus with each iteration, the number of pairs of audio clips is reduced by one, and after N−1 iterations, we have a single audio track covering the full duration of the event.

If the N clips were shot using M cameras, and M is less than N, even if the relative alignment of clips from different cameras is unknown, there are constraints on the relative alignments of multiple clips all shot from the same camera. For example, the cameras most likely have clocks, and even if those clocks have not been set, the differences in the timestamps on the clips from any single camera will still be valid. Thus the timestamps allow us to determine the relative alignment of all clips on a single camera. Even with no timestamps at all, the sequence of clips from a given camera will generally be known. For example, if a DV camera is used, the sequence in which the clips is recorded on tape generally corresponds to the sequence in which the events represented in those clips occurred in real life (the only exception being if someone rewinds the tape before recording a clip).

### Aligning Audio Tracks

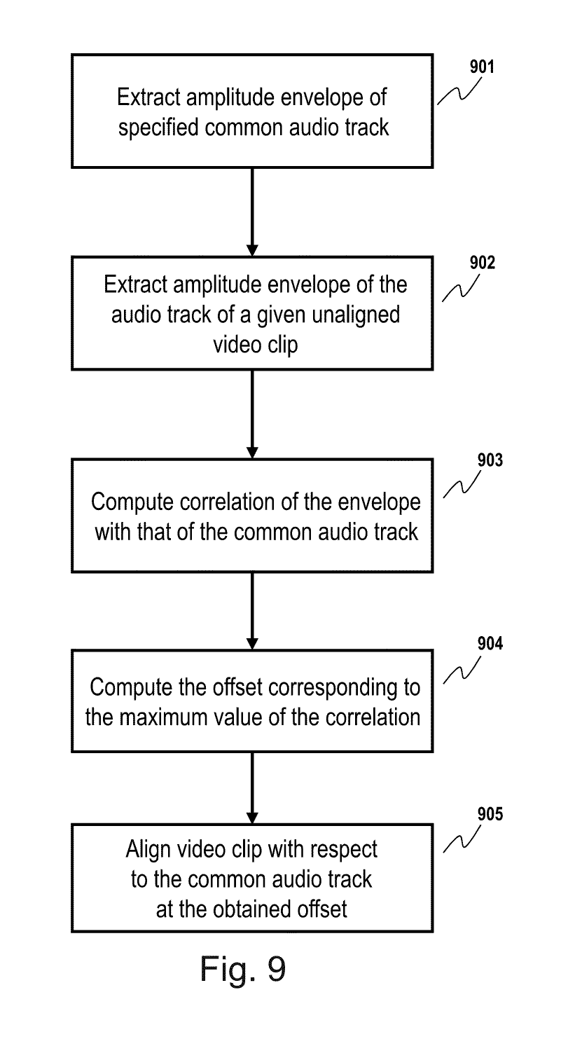

FIG. 9 is a flowchart summarizing the steps for one method of aligning a video clip with a reference audio track—the “common audio” track—using cross-correlation of the loudness envelope of the reference audio track and the audio track of the video clip.

In the first step 901, the amplitude envelope of the specified common audio track is extracted. Typically the amplitude envelope is computed by first taking the absolute value of each sample, low-pass-filtering the result, and then down-sampling. The sample rate of the envelope, post-down-sampling, need not be very high—just high enough to allow reasonable time resolution in the subsequent alignment steps. Given that video frame rates are typically 25-30 frames/s, time alignment to a resolution of 10 ms is sufficient, so an envelope sample rate of 100 Hz is sufficient.

In step 902, the amplitude envelope of the audio track of a video clip is computed using the same method described above for the common audio track.

In step 903, we compute the cross-correlation of the common audio track's amplitude envelope with that of the audio track of the video clip.

In step 904, we compute the relative time offset of the two tracks by locating the peak in the cross-correlation function. The cross-correlation of two vectors yields another vector whose values give an indication of the mathematical “closeness” of the two vectors as a function of shift or “lag”. The peak in the cross-correlation function corresponds to the best alignment.

In step 905, we align the video track with respect to the audio track using the offset computed in step 904.

### Other Methods for Aligning

The above steps outline just one of a variety of methods which exist for time-aligning audio tracks. Variants of the technique are possible and perhaps superior. All essentially involve computing one of more features derived from the tracks' audio samples, and determining a relative alignment or shift such that the correlation between the features of the tracks is maximized (or alternatively, such that the difference between the features of the tracks is minimized).

The amplitude envelope is just one of many possible features that can be used for the alignment. Others include the power envelope; cepstrum; spectrogram or STFTM (Short-Time Fourier Transform Magnitude); or outputs from multiple bandpass filters.

Each may have advantages for particular types of audio material. For example, the cepstrum is often used for analysis of speech signals, as it captures in a compact form the most salient features of a speech signal, in particular those which are most relevant to distinguishing between phonemes. For aligning multiple recordings of a speech, the cepstrum would therefore be an excellent choice, and would likely give much more reliable time alignment than the amplitude envelope.

### Additional Hints for Alignment

While the present invention is primarily concerned with aligning video files based on the content of their audio tracks, there may be additional information that can serve as hints for the alignment.

Devices capable of recording video have built-in clocks, and the video files they create include absolute timestamps. In cases where multiple videos from a single event are being aligned, the timestamps may be used to compute a first guess at the relative time alignment of the videos. Since clocks on devices may not be accurate and are seldom set precisely by users (or in the worst case never set at all), alignment based on timestamps is typically approximate. After initial alignment based on timestamps is performed, cross-correlation of features based on analysis of the audio tracks may be used to give more precise alignment.

In some live recording situations, certain video cameras may be positioned much further away from the subject and source of the common audio than others. This can result in slight inaccuracies in the time alignment of the visual if the alignment is done on the basis of audio alone. Suppose one video camera is 5 m away from the subject, and another is 20 m away. Sound travels at roughly 350 m/s, so if the two cameras are capturing audio from the subject using microphones attached to the cameras, the camera that's closer will record the sound about 43 ms earlier than the camera that's farther away. Light travels much faster (˜1 billion km/h)—for our purposes, effectively instantly compared to sound. So if videos from the two cameras are synchronized on the basis of the audio, the video content will be out of sync by 43 ms, more than the duration of one frame at typical frame rates. To address this, after synchronizing videos based on their audio tracks, one could do further automatic small (on the order of a few frames) adjustments to the alignment based on features obtained through analysis of the video. For example, if the video is shot at a rock concert, there may be pyrotechnics or other sudden changes in lighting that would be easily seen in the video shot with any of the multiple cameras. Alternatively, an interface can be provided to the user to manually fine-tune the timing for each camera after the automatic synchronization described here has been applied.

### Method for Constructing Given at Least Two Clips

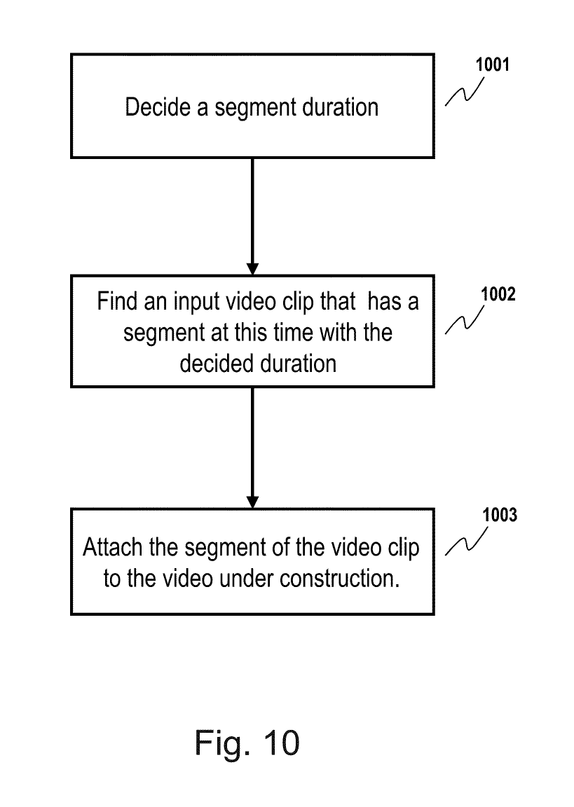

FIG. 10 is a flowchart for a method for constructing an output production given at least two time-aligned source video clips. It is one possible expansion of Steps 106 and 108 in FIG. 1. In Step 1001, we decide on the duration for a particular segment in the output production. In Step 1002, we choose material to fill that segment from one of the source video clips; that video clip must entirely cover the time-range of the required segment. In Step 1003, the selected video clip is attached to the video under construction.

We repeat the process of deciding on a segment duration, and selecting material to fill the segment from the time-aligned source video clips until the desired output production duration is reached. Note that one this repetition can be performed in various ways within the scope of the invention. For example, the embodiment could iterate either over all the steps of FIG. 10 (i.e. perform the set of steps 1001 to 1003 multiple times successively, so that in effect step 106 of FIG. 1 is not completed before step 108 is begun) or over each individual step. For example, we could compute all the segment durations first (i.e. perform step 1001 multiple times), and then proceed with selecting material to fill those segments (i.e. perform step 1002 multiple times, thereby completing step 106 of FIG. 1), and then attach the segments together (i.e. perform step 1003 multiple times, thereby performing step 108 of FIG. 1). Alternatively, we could select material immediately after each segment duration is computed.

### Highlights/Exclusions

When making a production with multiple video files all aligned to the same common audio tracks, it's quite likely that there are some particular shots that are especially desirable to include in the output production, and others that are of poor quality or otherwise undesirable and should be avoided if at all possible.

It's possible for such decisions to be made automatically to some degree. For example, there are well-known techniques to analyze video and detect whether it's solid black or out of focus. Given the results of such analysis, it would be straightforward to avoid using such objectively bad material in the output production.

In other cases, however, it's nearly impossible to automatically make all the appropriate editing decisions, as the decisions may depend on a deeper semantic understanding of the content. Consider for example, the scenario with multiple cameras capturing a performance of a band as shown in FIG. 6. Suppose one of the band members is a guitarist. When the guitarist is playing a solo, it would be desirable to switch to whichever camera angle shows him best. Conversely, if the guitarist is playing a relatively uninteresting accompanying rhythm part, it's probably best to avoid using a camera angle that puts undue focus on the guitarist.

Making such qualitative editing decisions is nearly impossible to do automatically, but can be done quite easily by having a user mark parts of the input video clips as highlights (“must include”) or exclusions (“must not include”).

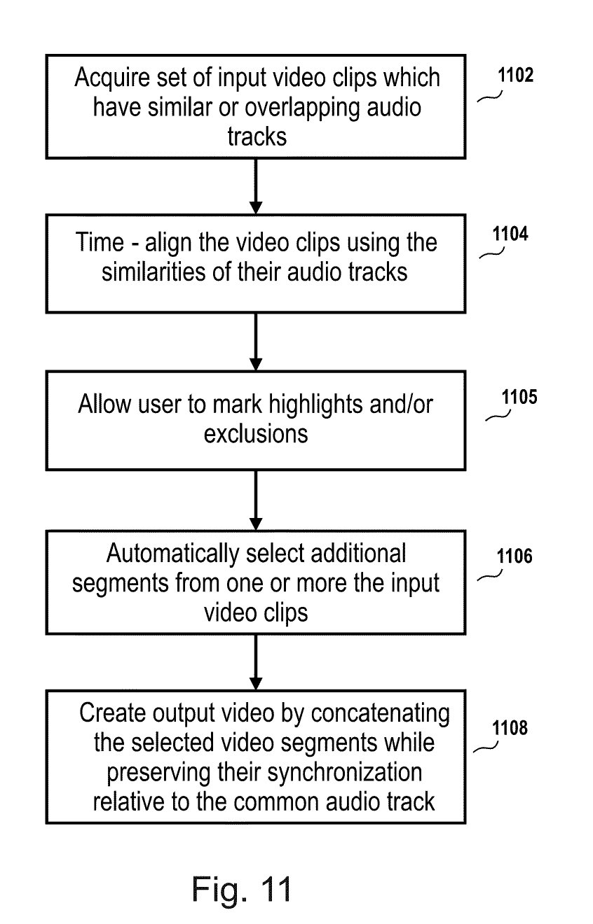

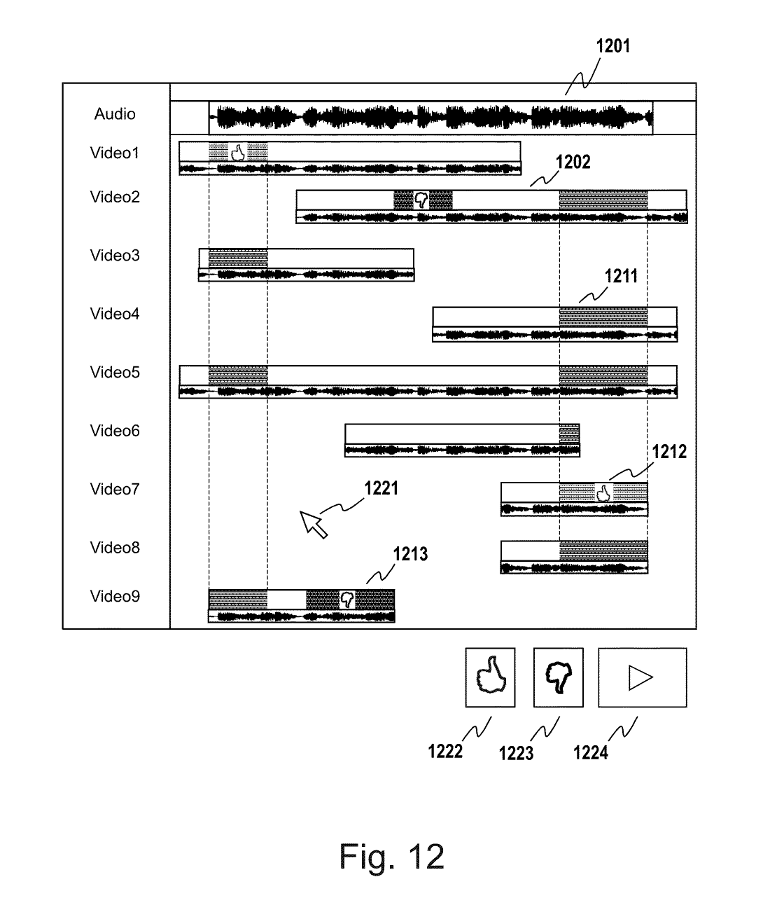

FIG. 11 is a variant of the flowchart of FIG. 1 with the additional step of allowing the user to mark highlights and/or exclusions. In the first step 1102, a set of video clips that have substantially similar or overlapping audio tracks is acquired. In the second step 1104, these video clips are time-aligned using similarities in their audio tracks as described above. In the third step 1105, the user is given the option of marking highlights and/or exclusions on any of the video clips (for example via a user interface such as that shown in FIG. 12). In the fourth step 1106, segments are automatically selected from one or more video clips. In the final step 1108, an output video is created by concatenating the selected video segments while preserving their synchronization relative to the common audio track.

FIG. 12 shows part of a possible user interface for indicating highlights and exclusions in multiple time-aligned video clips. Several source video clips (e.g. 1202) are shown time-aligned with the common audio track 1201. By clicking on a video clip using the mouse pointer 1221 and clicking the play button 1224, the user can view any of the source video clips on a preview screen.

The user can select any portion of a video clip by clicking and dragging using the mouse pointer 1221. The user can mark a selection as a highlight by clicking the highlight button 1222. The user can mark a selection as an exclusion by clicking the exclude button 1223. Highlights and exclusions can be indicated in the user interface via shading, colouring, and/or an icon, for example a thumbs up icon for a highlight 1212, and thumbs down for an exclusion 1213.

If any portion of a video clip is marked as a highlight, portions of other video clips that fall within the time range of the highlight will definitely not appear in the production (unless the output production shows multiple video sources simultaneously in a split screen view, which is not the case for typical video productions). Thus material in the other clips is in effect excluded. This can be indicated in the user interface by shading the effected portions of the clips, for example 1211.

Depending on the target use case, further user interface features may be desirable. A few of these features are briefly described here:
In cases where there is no separately recorded reference audio track (as illustrated in the construction diagram in FIG. 3), a feature can be provided to the user to choose the audio track of one of the input video files as the reference audio track.
Rather than specifying highlights and exclusions in a user interface that shows all the video clips at once, the user interface can allow the user to display and specify highlights and exclusions on one video file at a time. Alternatively, if the video files contain multiple shots, these can automatically be split into individual shots, and the user interface can allow the user to display and specify highlights and exclusions one shot at a time.
In some cases the alignment for the video clips with respect to the reference audio track may be ambiguous. For example, a band creating a music video for a song may shoot many takes each covering only short parts of the song. Those parts may sound very similar to other parts, e.g. in a typical pop song, the “chorus” is repeated several times, and all instances of the chorus sound very similar. In such cases, several almost equally good alignments may exist. The user interface can be provided with means allowing the user to drag the video clips forwards and backwards in time to change the time alignment, possibly “snapping” the alignment to the nearest likely automatically-determined alignment.
The reference audio track may be longer than the desired output production. This is not likely if the reference audio track is a pre-recorded audio track, for example a pop song from a CD or mp3, but is quite likely if the audio track from one of the video clips is chosen as the reference track. To cover such cases, a user interface feature to trim the reference audio track to the desired duration can be provided.

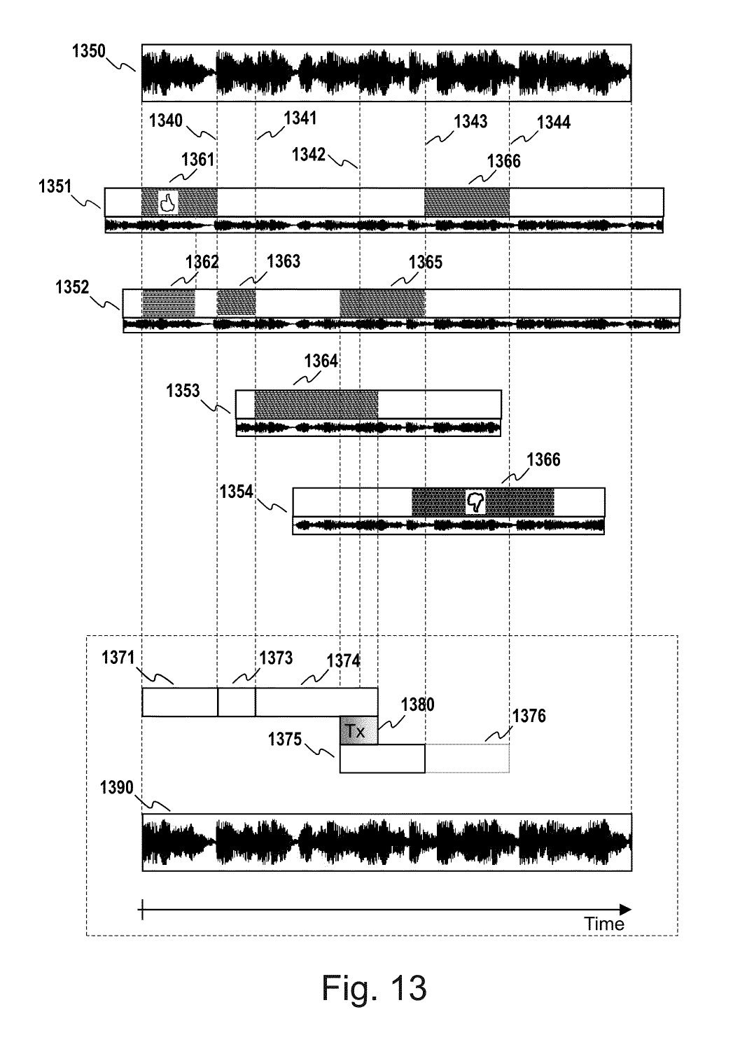

FIG. 13 is a construction diagram illustrating the creation of an output production from multiple video clips that are aligned to a reference audio track, and for which the user has marked some parts as highlights or exclusions.

Several input video clips 1351, 1352, 1353, 1354 are aligned to a reference audio track 1350. Video clips may cover the entire duration of the reference audio track, as is the case for clips 1351 and 1352, or they may cover only part of the duration, as is the case for clips 1353 and 1354.

A portion 1361 of one of the video clips is marked as a highlight, meaning it must be included in the output production. A portion 1366 of clip 1354 is marked as an exclusion, meaning it must not appear in the output production.

Using audio analysis methods such as those described, salient instants 1340, 1341, 1343, 1344 in the reference audio track are identified. In the case of music, salient instants would typically be strong beats. Many methods for detecting beats are described in the literature, for example in GB2380599.

Segments of the input video clips are automatically chosen to create the video part of the output production in such a way that the highlight is included, the exclusion is not used, and segments start and end at the salient instants in the reference audio track. Segment durations may also be determined or influenced by value cycling or according to music loudness. For example, the output production might intercut extremely rapidly between different source video clips in high-energy portions of the song, and linger on each video source longer during soft portions.

The highlight 1361 appears as part of segment 1371. Segment 1371 is longer than the highlight as its end time is chosen to correspond to a musically salient instant 1340 in the reference audio track. As a result of highlight 1361, portion 1362 of clip 1352 is effectively excluded (even though it has not been explicitly marked as excluded by the user). Various other segments 1363, 1364, 1365, 1366 of the input video clips are used to create further segments 1373, 1374, 1375, 1376 of the output production.

In order to make a more interesting production, it may be desirable to use video transitions in the output production, as opposed to simply concatenating segments with cuts, as shown for example with the dissolve 1380 between segments 1374 and 1375 during time Tx. A variety of methods exist to automatically choose transitions and their durations, including choosing on the basis of value-cycling and/or music loudness, as described in GB2380599. For example, the duration of the dissolve 1380 might be determined by the music loudness at the time 1342, usually at or near the mid point of the transition. Longer transitions during soft music and shorter transitions during high energy portions of music are considered to be effective in maintaining a strong correlation between the edited visual and its audio track.

For simplicity of illustration, in FIG. 13 only one of the input video files is used in the output production at any given time (apart from during the period Tx). However, it would also be possible to create output productions in which material from multiple input video files appears simultaneously in a “split screen” view.

Selection of Material from Input Video Clips

In all cases described above, there may be more than one possible way that material from the input video clips can be selected to fill the segments in the output production. For example, with reference to FIG. 2, a segment 203 from video clip 204 is used in the output production. However, a segment could instead have been taken from any other video clip that covers the same time range as 203, for example video clip 202.

If the user has specified highlights and exclusion, for example through a user interface as illustrated in FIG. 13, the number of possible ways to select video segments from the input video clips is likely to be reduced. However there may still be multiple possible ways for selected segments from the input video clips.

At times for which no highlight is specified by the user, the system will automatically select video from one or more of the input clips. Various algorithms and heuristics may be used:
Switch randomly. For each successive segment, use material from a different clip chosen randomly from those clips that cover the required time range for the clip.
Round robin. For each successive segment in the output, use material from the next available video clip. For example, if there are three clips (clip 1, clip 2 and clip 3), all of which cover the entire duration of the output production, choose segments in succession from clip 1, clip 2, and clip 3, then loop back to clip 1.
Use global view unless otherwise specified. In the Live-Event case, there may be one camera that's well positioned to get an overall global view of the entire event, for example a camera positioned far enough back from a stage to see all band members. One possible rule for selecting material for the output production could be to always use footage from that global view, unless there's a highlight on a video clip from one of the other cameras.
Cut to loudest. For any given output segment, use material from the video clip whose audio track is loudest over the time range of that segment. If the event was a panel discussion, and there was a camera (with microphone) close to each of the panellists, this heuristic would automatically cut to whichever camera is pointing at whoever is currently speaking.
Bias selection based on features of the video. Depending on the subject matter of the video, it may be desirable to cut to a particular camera/input clip based on easily detectable features in the video—brightness, presence of faces, and amount of motion or camera shake. Features in the user interface could allow the user to specify selection biases based on these features. This would, for example, allow the user to bias selection for each segment towards bright non-shaky content with faces.

### Templates

If the reference audio track is pre-recorded, as opposed to being taken from one of the video files, and if it's expected that multiple productions will be made using that same reference audio, it may be desirable to create a template specifying aspects of the production such as segment duration, transitions, and effects. After aligning user-supplied video with the reference audio track, segments from the user-supplied video clips would be automatically or semi-automatically selected to fill empty segments in the template.

If the reference audio is a song, and there's a pre-existing music video for that song, the template could further specify that some segments of the output production consist of material drawn from the pre-existing music video.

### Styles

Various aspects of the production may be influenced by a user-specified choice of editing “style”, as described in GB2380599. Aspects of the production that may be effected by a style include preferred segment duration; duration and types of transitions; and types of effects to be applied in the output production. Effects could including global effects applied for the entire duration of the production (for example, a grey-scale or other colouration effect); segment-level effects applied on individual segments of the production; and music-triggered effects such as zooms or flashes triggered on strong beats of the music.

The invention may be implemented as software running on a general purpose computer, such as a server or a personal computer. For example, it can be performed on a HP Compaq personal computer with a dx2700 tower and the Windows XP Professional operating system.

The computer may perform the invention by operating program instructions which is receives as part of a computer program product which may be either a signal (e.g. an electric or optical signal transmitted over the internet) or recorded on a tangible recording medium such as a CD-ROM. The output production may similarly be transmitted as a signal or recorded on a CD-ROM.

The term “automatic” as used in this document refers to a process step which is carried out by a computer program without seeking or making use of human input during the process step. That is, the automatic process step may be initiated by a human, and may comprise parameters set by the human in advance of the process being initiated, but there is no human involvement during the operation of the process step.

Although only a single embodiment of the invention has been described above, many modifications are possible within the scope of the invention as defined by the claims.

1. A computer-implemented method for producing a video production incorporating an output audio track and an output video track, the method comprising the steps of:
(a) obtaining a plurality of input video clips, each comprising a respective input video track and input audio track, said input audio track and input video track having a predefined temporal correspondence;
(b) obtaining a reference audio track;
(c) for each of said input video clips, establishing a respective first temporal mapping between the respective input audio track of the input video clip and the reference audio track by maximizing a measure of correlation of the respective input audio track with the reference audio track, the first temporal mapping and said predefined temporal correspondence determining a respective second temporal mapping between the reference audio track and the respective input video track of the corresponding input video clip;
(d) for each of a series of sections of the reference audio track, selecting one or more of the input video tracks, and forming segments of the one or more selected input video tracks which are the one or more respective portions of the one or more selected input video tracks corresponding to the section of the reference audio track under the one or more respective second temporal mappings; and
(e) combining the segments to produce the output video track having a temporal correspondence to the reference audio track, each segment having a temporal position in the output video track according to said corresponding second temporal mapping, the output audio track of the video production being the reference audio track.

2. A computer-implemented method according to claim 1 in which said reference audio track is a pre-existing audio track, and said step (b) includes receiving the reference audio track.

3. A computer-implemented method according to claim 1 in which said reference audio track is the input audio track of one of the input video clips.

4. A computer-implemented method according to claim 1 in which step (b) comprises constructing said reference audio track by combining portions of the respective input audio tracks of a plurality of said input video clips.

5. A computer-implemented method according to claim 1 in which said step (e) of combining the selected segments further includes combining at least a portion of a pre-existing video track having a pre-existing temporal relationship to said reference audio track, whereby said output video track includes the portion of the pre-existing video track at a temporal position determined by said temporal relationship.

6. A computer-implemented method according to claim 1 in which said step (d) is performed according to indications specified by a user, the indication including at least one of:
an indication that at least one of said video clips is to be selected during a specified section of said reference audio track; and
an indication that at least one of said input video clips is not to be selected during a specified section of the reference audio track.

7. A computer-implemented method according to claim 1 in which said step (d) comprises, for each said section of the reference audio track, determining a property of the each of input audio tracks during the portion of input audio tracks corresponding under said first mapping to the section of the reference audio track, and selecting the input video track which corresponds to the input audio track for which said determined property is greatest.

8. A computer-implemented method according to claim 1 in which a graphic user interface is presented to the user, the graphical user interface comprising a representation of each of the input video clips having a spatial position with respect to an axis representing time determined based on said second temporal mapping.

9. A computer-implemented method according to claim 8 in which the interface is operative to receive an instruction from the user to alter the second temporal mappings.

10. A computer-implemented method according to claim 1 in which said step (c) includes maximizing said measure of correlation with respect to a time warping between the respective input audio track and the reference audio track.

11. A computer-implemented method according to claim 1 in which one or more of said input video clips include time stamp data, and, for said one or more input video clips, said step (c) includes generating an approximate temporal mapping between said reference audio track and said respective input audio track based on said time stamp data, and refining said approximate temporal mapping by maximizing said measure of correlation to produce said first temporal mapping.

12-13. (canceled)

14. A computer system having a processor and software, the processor being operative, when running the software, to perform a method comprising the steps of:
(a) obtaining a plurality of input video clips, each comprising a respective input video track and input audio track, said input audio track and input video track having a predefined temporal correspondence;
(b) obtaining a reference audio track;
(c) for each of said input video clips, establishing a respective first temporal mapping between the respective input audio track of the input video clip and the reference audio track by maximizing a measure of correlation of the respective input audio track with the reference audio track, the first temporal mapping and said predefined temporal correspondence determining a respective second temporal mapping between the reference audio track and the respective input video track of the corresponding input video clip;
(d) for each of a series of sections of the reference audio track, selecting one or more of the input video tracks, and forming segments of the one or more selected input video tracks which are the one or more respective portions of the one or more selected input video tracks corresponding to the section of the reference audio track under the one or more respective second temporal mappings; and
(e) combining the segments to produce the output video track having a temporal correspondence to the reference audio track, each segment having a temporal position in the output video track according to said corresponding second temporal mapping, the output audio track of the video production being the reference audio track.

15. The computer system according to claim 14 in which said reference audio track is a pre-existing audio track, and said step (b) includes receiving the reference audio track.

16. The computer system according to claim 14 in which said reference audio track is the input audio track of one of the input video clips.

17. The computer system according to claim 14 in which step (b) comprises constructing said reference audio track by combining portions of the respective input audio tracks of a plurality of said input video clips.

18. The computer system according to claim 14 in which said step (e) of combining the selected segments further includes combining at least a portion of a pre-existing video track having a pre-existing temporal relationship to said reference audio track, whereby said output video track includes the portion of the pre-existing video track at a temporal position determined by said temporal relationship.

19. The computer system according to claim 14 in which said step (d) is performed according to indications specified by a user, the indication including at least one of:
an indication that at least one of said video clips is to be selected during a specified section of said reference audio track; and
an indication that at least one of said input video clips is not to be selected during a specified section of the reference audio track.

20. The computer system according to claim 14 in which said step (d) comprises, for each said section of the reference audio track, determining a property of the each of input audio tracks during the portion of input audio tracks corresponding under said first mapping to the section of the reference audio track, and selecting the input video track which corresponds to the input audio track for which said determined property is greatest.

21. The computer system according to claim 14 in which a graphic user interface is presented to the user, the graphical user interface comprising a representation of each of the input video clips having a spatial position with respect to an axis representing time determined based on said second temporal mapping.

22. The computer system according to claim 21 in which the interface is operative to receive an instruction from the user to alter the second temporal mappings.

23. The computer system according to claim 14 in which said step (c) includes maximizing said measure of correlation with respect to a time warping between the respective input audio track and the reference audio track.

24. A computer program product storing program instructions operative, when run by a processor, to perform a method comprising the steps of:
(a) obtaining a plurality of input video clips, each comprising a respective input video track and input audio track, said input audio track and input video track having a predefined temporal correspondence;
(b) obtaining a reference audio track;
(c) for each of said input video clips, establishing a respective first temporal mapping between the respective input audio track of the input video clip and the reference audio track by maximizing a measure of correlation of the respective input audio track with the reference audio track, the first temporal mapping and said predefined temporal correspondence determining a respective second temporal mapping between the reference audio track and the respective input video track of the corresponding input video clip;
(d) for each of a series of sections of the reference audio track, selecting one or more of the input video tracks, and forming segments of the one or more selected input video tracks which are the one or more respective portions of the one or more selected input video tracks corresponding to the section of the reference audio track under the one or more respective second temporal mappings; and
(e) combining the segments to produce the output video track having a temporal correspondence to the reference audio track, each segment having a temporal position in the output video track according to said corresponding second temporal mapping, the output audio track of the video production being the reference audio track.

25. The computer program product storing program instructions operative, when run by a processor according to claim 24 in which said reference audio track is a pre-existing audio track, and said step (b) includes receiving the reference audio track.

26. The computer program product storing program instructions operative, when run by a processor according to claim 24 in which said reference audio track is the input audio track of one of the input video clips.

27. The computer program product storing program instructions operative, when run by a processor according to claim 24 in which step (b) comprises constructing said reference audio track by combining portions of the respective input audio tracks of a plurality of said input video clips.

28. The computer program product storing program instructions operative, when run by a processor according to claim 24 in which said step (e) of combining the selected segments further includes combining at least a portion of a pre-existing video track having a pre-existing temporal relationship to said reference audio track, whereby said output video track includes the portion of the pre-existing video track at a temporal position determined by said temporal relationship.

29. The computer program product storing program instructions operative, when run by a processor according to claim 24 in which said step (d) is performed according to indications specified by a user, the indication including at least one of:
an indication that at least one of said video clips is to be selected during a specified section of said reference audio track; and
an indication that at least one of said input video clips is not to be selected during a specified section of the reference audio track.

30. The computer program product storing program instructions operative, when run by a processor according to claim 24 in which said step (d) comprises, for each said section of the reference audio track, determining a property of the each of input audio tracks during the portion of input audio tracks corresponding under said first mapping to the section of the reference audio track, and selecting the input video track which corresponds to the input audio track for which said determined property is greatest.

31. The computer program product storing program instructions operative, when run by a processor according to claim 24 in which a graphic user interface is presented to the user, the graphical user interface comprising a representation of each of the input video clips having a spatial position with respect to an axis representing time determined based on said second temporal mapping.

32. The computer program product storing program instructions operative, when run by a processor according to claim 31 in which the interface is operative to receive an instruction from the user to alter the second temporal mappings.

33. The computer program product storing program instructions operative, when run by a processor according to claim 24 in which said step (c) includes maximizing said measure of correlation with respect to a time warping between the respective input audio track and the reference audio track.
